(19) United States
(12) Patent Application Publication
(10) Pub. No.: US 2012/0017273 A1
(43) Pub. Date: Jan. 19, 2012

(54) APPARATUS AND METHOD FOR IMPROVING THE SECURITY IN PORTABLE COMMUNICATION SYSTEM

(75) Inventors: Jung-Hwan SON, Gyeonggi-do (KR); Oh-Hyuck KWON, Gyeonggi-do (KR); Kyung-Jin OH, Gyeonggi-do (KR)

(73) Assignee: SAMSUNG ELECTRONICS CO., LTD., Gyeonggi-Do (KR)

(21) Appl. No.: 13/178,733

(22) Filed: Jul. 8, 2011

(30) Foreign Application Priority Data
Jul. 19, 2010 (KR) 10-2010-0069556

(51) Int. Cl. G06F 21/00

(52) U.S. Cl. 726/20

(57) ABSTRACT

An apparatus for improving the security of a portable communication terminal includes: a security card having a plurality of projections provided in a predetermined projection form that is capable of identifying a user; and an authentication managing unit for analyzing the projection form, which is detected through a touch input of the security card, and performing an authentication process using the analyzed outcome.

### CLAIM OF PRIORITY

This application claims the benefit of priority under 35 U.S.C. §119(a) from a Korean patent application filed in the Korean Intellectual Property Office on Jul. 19, 2010 and assigned Serial No. 10-2010-0069556, the entire disclosure of which is hereby incorporated by reference in its entirety.

### BACKGROUND OF THE INVENTION

1. Field of the Invention

The present invention relates to an authentication technology used in a portable communication terminal. More particularly, the present invention relates to an apparatus and method for improving the security of a portable communication terminal for its intended users.

2. Description of the Related Art

Portable communication terminals have been rapidly developed in recent years. In particular, portable communication terminals capable of wireless voice and data communication have become an indispensible part of our daily life. Due to the development of technologies and the introduction of wireless Internet, the applications of the portable communication terminals have been growing to meet users' demands. For example, the portable communication terminals can now provide a phone call function, a scheduling function, a game function, a remote control function using near-field communication, a photographing function using a built-in digital camera, and so on.

Since the portable communication terminals also provide a storage medium function, users can store a variety of personal information in their portable communication terminals. To this end, the portable communication terminals provide a password-based security function in order to prevent malicious use of personal information.

However, the above-mentioned password-based security function cannot provide a robust security system because a password consists of a simple combination of numbers. For example, if a four-digit password is set to a portable communication terminal, a person may decrypt the set password by inputting numbers from 0000 to 9999. Once the password is decrypted, an unauthorized person may use the pre-stored personal information.

To solve the above-mentioned problem, there is a need for an apparatus and method for reinforcing a security function in a portable communication terminal.

### SUMMARY OF THE INVENTION

An exemplary aspect of the present invention is to provide an apparatus and method for improving the security of a portable communication terminal.

Another exemplary of the present invention is to provide an apparatus and method for increasing the number of settable security information in a portable communication terminal.

Another exemplary of the present invention is to provide an apparatus and method for generating security information using protrusion of a security card in a portable communication terminal.

In accordance with an aspect of the present invention, an apparatus for improving the security of a portable communication terminal includes a security card having a plurality of projections extended therefrom in a predetermined pattern, defining a projection form that is capable of identifying an authorized user; and an authentication managing unit for analyzing the projection form, which is detected through a touch input by the security card, and performing an authentication process using the analyzed outcome.

In accordance with another aspect of the present invention, a method for improving the security of a portable communication terminal includes performing a touch input of a security card having a plurality of projections in a predetermined pattern that is configured in a projection form to identify an authorized user; detecting a projection form through the touch input of the security card; and analyzing the detected projection form and performing an authentication process using the analyzed outcome.

In accordance with another aspect of the present invention, an apparatus for improving the security of a portable communication terminal includes a security card for assigning different projection forms to different users for identification purposes; a memory unit for storing projection form information used to determine whether authentication of the security card is successful; a projection input unit for receiving the projection form of the security card; and an authentication managing unit for analyzing the projection form received through the projection input unit and performing an authentication process.

### BRIEF DESCRIPTION OF THE DRAWINGS

The above and other exemplary aspects, features and advantages of the present invention will become more apparent to a person of ordinary skill in the art from the following detailed description when taken in conjunction with the accompanying drawings in which:

FIG. 1 is a block diagram of a portable communication terminal according to an embodiment of the present invention;

FIG. 2 is a flowchart illustrating a process of authenticating a user of a portable communication terminal according to an embodiment of the present invention;

FIG. 3 is a flowchart illustrating an authentication process in a portable communication terminal according to an embodiment of the present invention;

FIG. 4A is a diagram illustrating a structure of a security card according to an embodiment of the present invention;

FIG. 4B is a diagram illustrating a structure of a security card according to another embodiment of the present invention;

FIG. 5A is a diagram illustrating a portable communication terminal and a security card according to an embodiment of the present invention;

FIG. 5B is a diagram illustrating a situation in which a security card comes into close contact with a portable communication terminal according to an embodiment of the present invention; and

FIG. 5C is a diagram illustrating a process of detecting projections of a security card in a portable communication terminal according to another embodiment of the present invention.

### DETAILED DESCRIPTION

Preferred embodiments of the present invention will be described herein below with reference to the accompanying drawings. For the purposes of clarity and simplicity, detailed descriptions of well-known functions or configurations will be omitted as they would unnecessarily obscure the subject matters of the present invention.

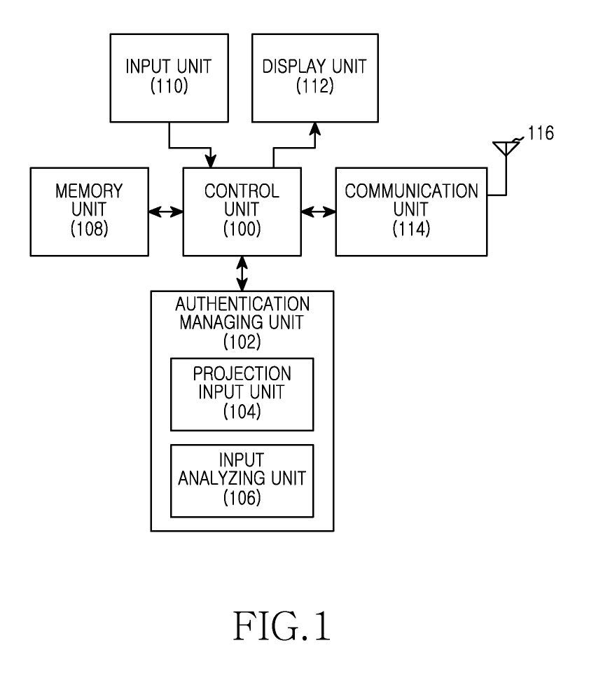

FIG. 1 is a block diagram of a portable communication terminal, which performs an authentication process, according to an embodiment of the present invention.

Referring now to FIG. 1, the portable communication terminal may include a control unit 100, an authentication managing unit 102, a memory unit 108, an input unit 110, a display unit 112, and a communication unit 114. The authentication managing unit 102 may include a projection input unit 104 and an input analyzing unit 106. The functionality of two or more of the above units may be integrated into a single component. The portable communication terminal may include additional units that are not illustrated here for sake of clarity.

In operation, the control unit 100 controls an overall operation of the portable communication terminal. For example, the control unit 100 processes and controls voice and data communication. In addition, if a touch input using a security card according to an embodiment of the present invention is detected, the control unit 100 uses the analysis result of the detected touch input in an authentication process.

The security card having a plurality of projections extended therefrom in a predetermined projection form is designed to represent a large number of classes and provide user identification information for different users. Accordingly, the control unit 100 detects a pattern of a projection that generates the touch input, and uses the detection result in the authentication process.

Under the control of the control unit 100, the authentication managing unit 102 detects the projection form inputted to a touch screen and performs a user authentication process.

The projection input unit 104 of the authentication managing unit 102 is a touch screen that can receive the projection input of the security card to detect the projection form/pattern, and may use a resistive touch screen panel to recognize the projection patterns of the security card. The projection input unit 104 may be configured in a minimum size adequate enough to detect the projection form. In other words, the projection input unit 104 detects the touch input through the projections of the security card and provides the detected touch input to the input analyzing unit 106.

The input analyzing unit 106 of the authentication managing unit 102 determines the projection form by analyzing the touch input detected by the projection input unit 104. In other words, the portable communication terminal may determine the user of the security card using the projection form analyzed by the input analyzing unit 106. Therefore, it is possible to determine whether the user of the security card is an authenticated user.

The memory unit 108 may include non-transitory machine readable medium(s), such as Read Only Memory (ROM), Random Access Memory (RAM), a flash ROM, or other similar storage devices. The ROM stores a variety of reference data and microcodes of a program for the process and control of the control unit 100 and the authentication managing unit 102.

The RAM is a working memory of the control unit 100, which stores temporary data generated during the execution of various programs. The flash memory stores a variety of updatable data such as phone numbers, outgoing messages, and incoming messages.

The input unit 110 may include numeric keys of 0-9 and a plurality of function keys, such as a Menu key, a Cancel key, a Confirmation key, a Talk key, an End key, an Internet Connection key, and Navigation keys (or arrow keys). The input unit 110 provides the control unit 100 with key input data (e.g., an authentication execution request) that corresponds to a key pressed by a user.

The display unit 112 may displays numerals and characters, moving pictures, still pictures, and status information generated during the operation of the portable communication terminal. The display unit 112 may comprise a color Liquid Crystal Display (LCD), an Active Mode Organic Light Emitting Diode (AMOLED) display, and/or other types of thin-film technology screen display apparatuses. The display unit 112 displays a combined character according to the user's touch input.

The communication unit 114 transmits/receives Radio Frequency (RF) signals inputted/outputted through an antenna 116. For example, in a transmitting (TX) mode, the communication unit 114 channel-codes, spreads and RF-processes TX data prior to transmission. In a receiving (RX) mode, the communication unit 114 converts a received RF signal into a baseband signal and dispreads and channel-decodes the baseband signal to restore the original data. The communication unit 114 could also include a communication port for wired transfer, such as USB, and may also communicate in short-range protocols such as Bluetooth, etc. For example, time division, frequency division, are just a few examples of possible protocols. It is also to be appreciated by a person of ordinary skill in the art that the communication protocol is in no way limited to spread spectrum techniques.

The control unit 100 of the portable communication terminal may be configured to perform the functions of the authentication managing unit 102. The authentication managing unit 102 is separately illustrated for convenience of explanation and is merely exemplary. The present invention is not limited to the above exemplary structure. It is apparent to those skilled in the art that various modifications may be made within the scope of the present invention. For example, the control unit 100 may also be configured to perform all the functions of the separate units.

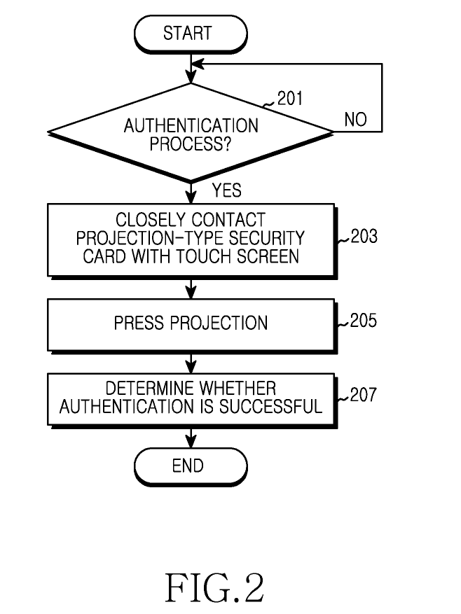

FIG. 2 is a flowchart illustrating a procedure of authenticating a user of a portable communication terminal according to an embodiment of the present invention.

Referring now to FIG. 2, the user of the portable communication terminal determines whether to perform an authentication process in step 201.

If the user of the portable communication terminal does not determine to perform the authentication process in step 201, the user of the portable communication terminal repeats step 201.

Meanwhile, if the user of the portable communication terminal determines to perform the authentication process in step 201, the user of the portable communication terminal proceeds to step 203 to closely contact a projection type security card with the touch screen of the portable communication terminal or closely place near the touch screen.

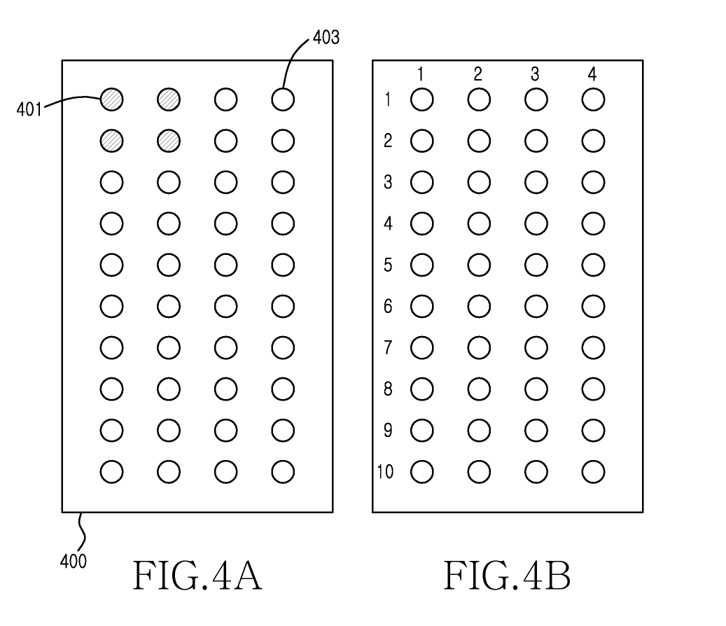

As illustrated in FIG. 4, the security card having a number of projections mounted thereon in different patterns is designed to represent a large number of users. Projection patterns can be created at a part of the ensured positions according to a user's feature for different applications. In addition, the user of the portable communication terminal may improve a recognition rate of the security card by closely contacting the security card with the security card input region displayed on the touch screen. A minimum region capable of recognizing the projection form of the security card is predefined as the input region on the touch screen. Accordingly, when an exact projection-type input is achieved, the input region is minimized, and the size of the touch screen can be minimized.

Then, the user of the portable communication terminal proceeds to step 205 to perform a touch input using the projection region of the security card. The portable communication terminal may use a resistive touch screen panel so as to recognize the projections of the security card. The user of the portable communication terminal presses the projection region of the security card with the user's finger.

The user of the portable communication terminal, who has pressed the projection region of security card, proceeds to step 207 to determine whether the authentication process is successful, and ends the algorithm.

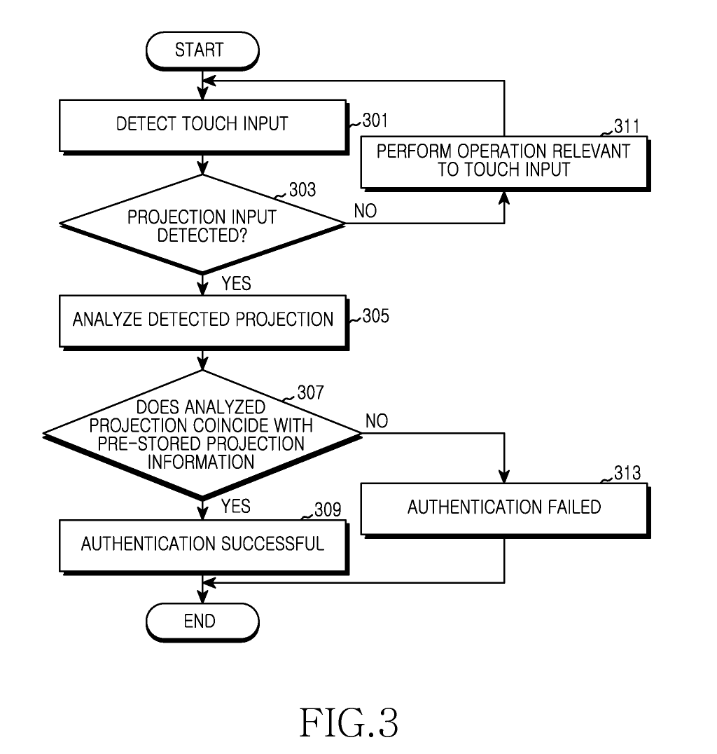

FIG. 3 is a flowchart illustrating an authentication process in a portable communication terminal according to an embodiment of the present invention.

Referring now to FIG. 3, the portable communication terminal detects a touch input in step 301. The touch input refers to a touch input for controlling the operation of the portable communication terminal, and a touch input for the authentication process using the projections of the security card.

Then, the portable communication terminal proceeds to step 303 to distinguish a type of the touch input detected in step 301.

If the touch input for controlling the operation of the portable communication terminal is detected in step 303, the portable communication terminal proceeds to step 311 to perform an operation relevant to the detected touch input, and returns to step 301.

Meanwhile, if the touch input using the projections of the security card is detected in step 303, the portable communication terminal proceeds to step 305 to analyze the detected projections.

The projection patterns defines different user's information, and the enterprise may manufacture security cards having different projection forms for each user and provide the users with the security cards. Therefore, the portable communication terminal may determine the user corresponding to the security card by analyzing the detected projection patterns.

Then, the portable communication terminal proceeds to step 307 to determine whether the authentication process is successful by comparing the projections analyzed in step 305 with pre-stored projection information.

If it is determined in step 307 that the projections analyzed in step 305 do not coincide with the pre-stored projection information, the portable communication terminal proceeds to step 313 to determine that the authentication process is failed.

Meanwhile, if it is determined in step 307 that the projections analyzed in step 305 coincide with the pre-stored projection information, the portable communication terminal proceeds to step 309 to determine that the authentication process is successful.

The portable communication terminal having determined whether the authentication process is successful or failed outputs the result of the authentication process and ends the algorithm.

Although the projection-type security card is used in FIG. 3 in order to solve the problems of the conventional password-based security function, the combination of the security function according to the embodiment of the present invention and the conventional security function may be applied to the functions requiring other higher security (e.g., mobile payment, personal information, confidential document storage, etc.), thereby improving the security of the portable communication terminal.

FIGS. 4A and 4B are diagrams illustrating a structure of a security card according to embodiments of the present invention.

Specifically, FIG. 4A is a diagram illustrating a structure of a security card according to an embodiment of the present invention.

Referring now to FIG. 4A, a security card 400 is designed to represent a user's feature using a particular projection form. The projection form may be created differently for each user. The security card 400 is provided with a plurality of projection at different positions assigned to different users. For example, as illustrated, the security card 400 creates projections only at shaded positions 401 among the positions indicated by circles. In this manner, the use's feature can be represented. The projections are created in different forms for each user. The security card 400 may use any one direction sequentially selected among a left-to-right direction, a right-to-left direction, a downward direction, and an upward direction. This means that four users' features can be represented according to directionality with respect to the same projection form, thus increasing number of users for identification purposes using the same projection pattern in different direction.

For example, if the projections are created in a 5×5 form, the number of cases is 3,125. However, if using the directionality, the number of cases becomes 3,125×4=12,500. This means that even though twenty-five projections are used, the number of cases is increased more than 10,000, which is the number of cases of the conventional password scheme. In addition, for a user's convenience, the projection form of the security card is set to a size corresponding to an area that is contacted with a touch screen. Therefore, the touch input using the security card may be easily achieved.

FIG. 4B is a diagram illustrating a structure of a security card according to another embodiment of the present invention.

Referring now to FIG. 4B, the security card may be used as a security code for mobile payment. A general security code is provided in a form of a plastic card with four-digit numbers. Thus, the user performs an authentication process using the first two-digit numbers and the last two-digit numbers of the number requested by the system.

In the case of such a security card, there is an inconvenience in that the user should always carry the security card because unauthorized persons may use it if unique numbers are exposed.

However, according to the embodiment of the present invention, the projection form is combined with a portable financial card, and numbers are assigned to each projection-type row and column. Then, an authentication process may be performed using projections located at specific positions. For example, the conventional code input process may be replaced by inputting a second column in an upward direction or a ninth row in a right-to-left direction in the security card on a security card input window.

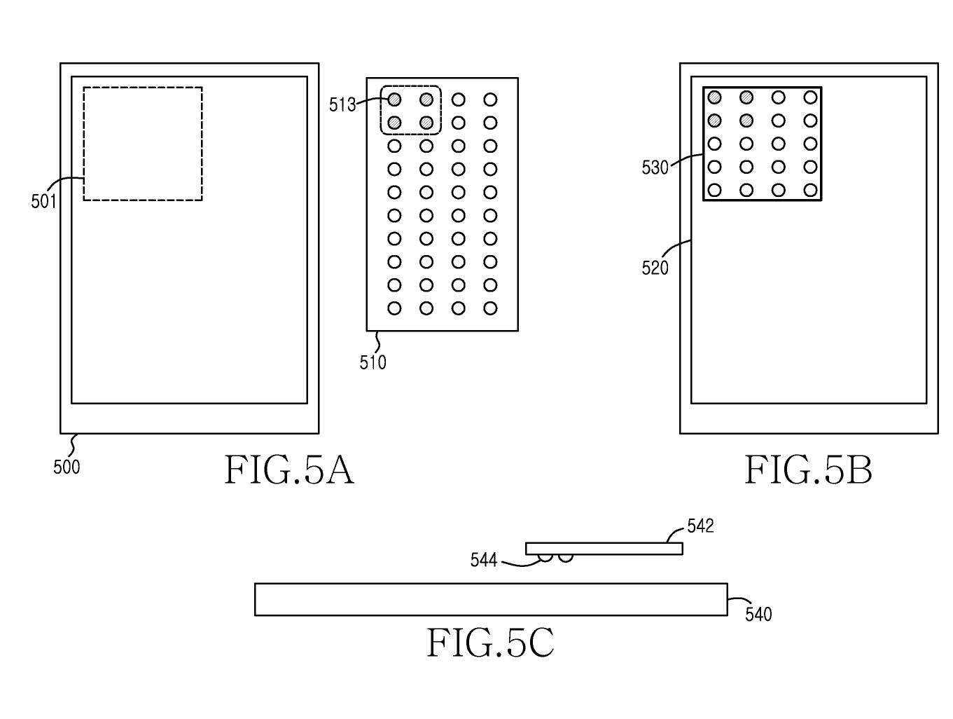

FIGS. 5A to 5C are diagrams illustrating an authentication process of a portable communication terminal according to an embodiment of the present invention.

Specifically, FIG. 5A is a diagram illustrating a portable communication terminal and a security card according to an embodiment of the present invention.

Referring now to FIG. 5A, the portable communication terminal 500 includes a touch screen that is capable of detecting an input of the security card. In this case, the portable communication terminal may use a resistive touch screen panel in order to recognize projections of the security card, and may use a region 501 of the touch screen as a region for detecting the input of the security card.

The security card 510 is configured in a projection form as indicated by reference numeral 513.

FIG. 5B is a diagram illustrating a situation in which a security card comes into close contact with a portable communication terminal according to an embodiment of the present invention.

Referring now to FIG. 5B, the user of the portable communication terminal 520 closely contacts the security card 530 with the touch screen thereof in order to perform the authentication process. Then, the user of the portable communication terminal 520 presses the projections of the security card 530 with his or her fingers. After detecting the projection patterns, the portable communication terminal 520 compares the information on the detected the projection patterns with the pre-stored information and performs the authentication process with respect to the security card 530.

FIG. 5C is a diagram illustrating a process of detecting projections of a security card in a portable communication terminal according to an embodiment of the present invention.

Referring now to FIG. 5C, the security card 542 may include a plurality of projections 544. As described above, the projections 544 are information indicating a user's feature, and the portable communication terminal determines the projection form through the touch input.

As illustrated in FIG. 5C, a situation in which the security card 542 contacts the touch screen 540 means that a user intends to perform an authentication process. The user inputs the projections 544 to the touch screen 540 by pressing the security card 542.

In this case, the touch screen 540 may use a resistive touch screen panel in order to recognize the projections 544. If the touch screen does not support a multi-touch, the user allows the portable communication terminal to recognize the projection patterns by pressing the projections of the security card in consecutive order.

As described above, security information is generated using the projections of the security card in order to improve the security of the portable communication terminal, thereby increasing the number of cases of the security information of the existing security card.

The above-described methods according to the present invention can be implemented in hardware, firmware or as software or computer code that can be stored in a recording medium such as a CD ROM, an RAM, a floppy disk, a hard disk, or a magneto-optical disk or downloaded over a network and stored on a non-transitory machine readable medium, so that the methods described herein can be rendered in such software using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the invention has been shown and described with reference to certain preferred embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. An apparatus for improving the security of a portable communication terminal, comprising:
a security card having a plurality of projections provided in a predetermined projection form defining a specific user; and
an authentication managing unit for analyzing the predetermined projection form detected via a touch input of the security card for comparison and performing an authentication process using the analyzed outcome.

2. The apparatus of claim 1, wherein the detected predetermined projection form is compared to a pre-stored data for authentication.

3. The apparatus of claim 1, wherein the authentication managing unit detects the touch input on a touch screen corresponding to the projections of the security card.

4. The apparatus of claim 1, wherein the authentication process comprises contacting a portion of a touch screen representing the predetermined projection form projected on the touch screen.

5. The apparatus of claim 1, wherein the security card is configured with different projection forms for each user.

6. The apparatus of claim 1, wherein the predetermined projection form defined in the security card represents a combination of numbers defining a security code.

7. The apparatus of claim 1, wherein the predetermined projection form defined in the security card is provided in a portable card to serve as a security code.

8. A method for improving the security of a portable communication terminal, comprising:
performing a touch input of a security card having a plurality of projections that is configured in a predetermined projection form to determine a specific user;
detecting the predetermined projection form through the touch input of the security card; and
analyzing the detected projection form for comparison and performing an authentication process using the analyzed outcome.

9. The method of claim 8, wherein the detected predetermined projection form is compared to a pre-stored data for authentication.

10. The method of claim 8, wherein the touch input of the security card includes inputting a touch screen through the projections of the security card.

11. The method of claim 10, wherein the authentication process comprises contacting a portion of a touch screen representing the predetermined projection form projected on the touch screen.

12. The method of claim 8, wherein the security card is configured with different projection forms for each user.

13. The method of claim 8, wherein the predetermined projection form defined in the security card represents a combination of numbers defining a security code.

14. The method of claim 8, wherein the predetermined projection form defined in the security card is provided in a portable card to serve as a security code.

15. An apparatus for improving the security of a portable communication terminal, comprising:
a security card for assigning different projection forms to define different users;
a memory unit for storing projection form information used to determine whether authentication of the security card is successful;
a projection input unit for receiving the projection form of the security card; and
an authentication managing unit for analyzing the projection form received through the projection input unit and performing an authentication process.

16. The apparatus of claim 15, wherein the projection form received through the projection input unit is compared to a pre-stored data for authentication.

17. The apparatus of claim 15, wherein the authentication process comprises contacting a portion of a touch screen representing the predetermined projection form projected on the touch screen.

18. The apparatus of claim 15, wherein the predetermined projection form defined in the security card represents a combination of numbers defining a security code.

19. The apparatus of claim 15, wherein the predetermined projection form defined in the security card is provided in a portable card to serve as a security code.

20. The apparatus of claim 15, wherein the projection input unit includes a resistive touch screen panel.
